(19) United States
(12) Patent Application Publication
(10) Pub. No.: US 2020/0316802 A1
(43) Pub. Date: Oct. 8, 2020

(54) Razor Blade

(71) Applicant: BIC-VIOLEX SA, ANIXI, ATTIKI (GR)

(72) Inventors: Labros KONTOKOSTAS, P.FALIRO ATHENS (GR); loannis PAPATRIANTAFYLLOU, MAROUSI ATHENS (GR); Taxiarchis TERLILIS, ATHENS (GR); Anastasios SIOZIOS, MAROUSI ATHENS (GR); Konstantinos MAVROEIDIS, PAPAGOS ATHENS (GR)

(21) Appl. No.: 16/491,951

(22) PCT Filed: Mar. 5, 2018
(86) PCT No.: PCT/EP2018/055383

§ 371 Date: Sep. 6, 2019

(30) Foreign Application Priority Data
Mar. 8, 2017 (EP) 17159912.9

(51) Int. Cl. B26B 21/60; B26B 21/56

(52) U.S. Cl. CPC B26B 21/60; B26B 21/56

(57) ABSTRACT

A razor blade has a symmetrical tapering blade edge ending in a blade tip. The razor blade includes a substrate and a coating covering the substrate. The coating includes a soft coating and a hard coating. The hard coating includes at least a main layer. The soft coating covers the hard coating. The substrate includes a substrate tip having specific a thickness at distances of 5 micrometers, 20 micrometers, 40 micrometers, and 250 micrometers from the substrate tip.

### CROSS REFERENCE TO RELATED APPLICATIONS

This application is a National Stage Application of International Application No. PCT/EP2018/055383, filed on Mar. 5, 2018, now published as WO2018/162432 and which claims priority to application Ser. No. 17/159,912.9, filed Mar. 8, 2017, the entire contents of which is incorporated herein by reference.

### FIELD

The disclosure relates to razors and more particularly to razor blades wherein the cutting area of the razor blade is profiled.

### BACKGROUND

The shape of a razor blade edge plays an important role in the quality of the shaving. The razor blade typically has a continuously tapering shape converging toward an ultimate tip. The portion of the razor blade which is closest to the ultimate tip is called the edge tip.

If the edge tip is thick, it will enable less wear and a longer service life, but it would result in larger cutting forces, which adversely affect the shaving comfort. A thin edge tip profile leads to less cutting forces but also to an increase in risk of breakage or damage, and a shorter service life. Therefore, a cutting edge of a razor blade for which an optimal trade-off between the cutting forces, the shaving comfort and the service life is attained is desired.

To achieve the aforementioned object, the cutting edge of the razor blade is shaped. The shape of the razor blade can be the result of a grinding process.

Many documents mainly refer to the shape of the coated blade without detailing the shape of the underlying substrate, or simply by defining the included angle.

Although it can be considered that a thinner edge tip of the blade might present certain advantages, the definition of this geometry itself is not sufficient because, as mentioned above, such an edge might be weak. The applicant has performed intensive work in order to determine the characteristics of the blade which, overall, could be beneficial when looking for a thinner edge geometry.

Enhancing razor blade properties is an extremely difficult process. First, razor blades are manufactured using an industrial process with very high throughput (millions of products per month). Second, in order to know if a new razor blade provides enhanced performance, tests which simulate shaving must be performed, the results of which have to be correlated with razor blade properties.

Further, the dispersion of the measurement method is also to be taken into account when assessing the measurement results.

It is an object of the disclosure to provide a razor blade, suitable for a razor head of a shaving device, wherein the fluidity is improved while maintaining durability, compared to the current state of the art.

### SUMMARY

Accordingly, in embodiments, disclosed are razor blade substrates with a symmetrical tapering blade edge ending in a blade tip, the razor blade comprising a substrate and a coating covering the substrate, the coating comprising a soft coating and a hard coating, the hard coating comprising at least a main layer, the soft coating covering the hard coating, wherein the substrate has a substrate tip with a thickness comprised between 1.30 micrometers and 2.00 micrometers measured at a distance of 5 micrometers from the substrate tip, a thickness comprised between 4.00 micrometers and 6.00 micrometers measured at a distance of 20 micrometers from the substrate tip, a thickness comprised between 8.00 micrometers and 11.50 micrometers measured at a distance of 40 micrometers from the substrate tip, and a thickness comprised between 41.70 micrometers and 47.00 micrometers measured at a distance of 250 micrometers from the substrate tip. Unless explicitly stated otherwise, all blade edge measurement data provided in the claims are obtained through confocal microscopy measurements.

Generally, thicker edge profile within the first 40 micrometers (μm) from the substrate tip provides an increased durability. This is expected to have a negative effect on fluidity. However, taking into consideration the fact that during shaving the razor blade remains in contact with the hair for the total grinded area, it has been found that decreasing the thickness beyond 40 μm could have a positive impact on fluidity, while maintaining durability.

One known method for measuring blade edge geometry is using a scanning-electron microscope (SEM). SEM is performed on a blade cross-section.

A SEM photo of the blade tip cross-section is used. The magnification is selected based on the distance from the tip where edge thickness needs to be measured. For example, for edge thickness measured up to 20 μm from the tip, a 3,500× magnification may be used. The specimen must be inserted into the chamber such that the electron beam strikes the blade cross-sectional surface perpendicularly. The image produced is then analyzed using a special image processing software.

In some embodiments, a person of ordinary skill in the art might also use one or more of the following features:

The substrate has a profile which has one, two or three facets, each facet having a continuous tapering geometry;

The substrate has a thickness comprised between 6.00 micrometers and 8.70 micrometers measured at a distance of 30 micrometers from the substrate tip;

The substrate has a thickness comprised between 10.00 micrometers and 14.00 micrometers measured at a distance of 50 micrometers from the substrate tip; The substrate has a thickness comprised between 19.00 micrometers and 24.00 micrometers measured at a distance of 100 micrometers from the substrate tip;

The substrate has a thickness comprised between 27.70 micrometers and 32.00 micrometers measured at a distance of 150 micrometers from the substrate tip;

The substrate has a thickness comprised between 34.70 micrometers and 40.00 micrometers measured at a distance of 200 micrometers from the substrate tip;

The substrate has a thickness comprised between 48.70 micrometers and 54.00 micrometers measured at a distance of 300 micrometers from the substrate tip;

The substrate has a thickness comprised between 55.70 micrometers and 61.00 micrometers measured at a distance of 350 micrometers from the substrate tip;

The substrate has a substrate tip and a tapering geometry toward the substrate tip;

The hard coating comprises at least a main layer;

The main layer is a strengthening coating; applying a hard coating or strengthening coating as a main layer enhances shaving performances and durability.

The main layer comprises Chromium (Cr), Chromium-Platinum (Cr—Pt) mixtures, Chromium-Carbide (Cr—C) mixtures, diamond, diamond like carbon (DLC), nitrides, carbides, oxides and/or borides; The main layer provides corrosion resistance and edge strengthening to the razor blade;

The hard coating may further comprise an interlayer, the interlayer been located between the substrate and the main layer; the interlayer is used to facilitate the bonding of the main layer with the substrate;

The interlayer comprises chromium (Cr), titanium (Ti), niobium (Nb), molybdenum (Mo), aluminum (Al), nickel (Ni), copper (Cu), zirconium (Zr), tungsten (W), vanadium (V), silicon (Si) and/or cobalt (Co) and/or any alloy and/or any combination of them;

The hard coating may further comprise an overcoat layer, the overcoat layer being located between the main layer and the soft coating;

The main layer may be covered by an overcoat layer; the overcoat layer is used to facilitate bonding of the lubricating coating to the main layer;

The overcoat layer comprises chromium (Cr), titanium (Ti), niobium (Nb) and/or molybdenum (Mo) and/or any alloy and/or any compound of them. In another embodiment titanium diboride can be used as a main layer.

The overcoat layer may be covered by the soft coating which is a lubricating layer; the lubricating can be hydrophobic or hydrophilic, such as polyfluorocarbon, for example polytetrafluoroethylene (PTFE); this coating provides a reduction of the friction between the razor head and the skin;

The deposition of the layers can be made with various Physical Vapor Deposition techniques, such as Sputtering, RF-DC Magnetron Sputtering, Reactive Magnetron Sputtering, Unbalance Magnetron Sputtering, E-Beam evaporation, Pulsed Laser deposition or cathodic arc deposition;

The substrate of the blade is made of raw material e.g., stainless steel, which has previously been subjected to a metallurgical treatment. For instance, the blade substrate comprises mainly iron, and, in weight C: 0.40-0.80%; Si: 0.10-1.5%; Mn: 0.1-1.5%; Cr: 11.0-15.0%; and Mo: 0.0-5.0%. Other stainless steels can be used within the disclosure. Other materials which are known as razor blade substrate materials, could be considered.

A further object of the disclosure is to provide a shaving device comprising a razor handle and a razor head, wherein said razor head comprises at least one razor blade according to the disclosure.

Yet a further object of the disclosure is to provide a razor head having a housing comprising at least one razor blade according to the disclosure. Another object of the disclosure is to provide a shaving device comprising a razor handle and such a razor head.

According to some specific embodiments, the thickness range between 40 μm and 350 μm distance from the hard coating tip is important to be satisfied in order to achieve the desired geometry for shaving comfort and blade durability.

### BRIEF DESCRIPTION OF THE DRAWINGS

Other characteristics and advantages will readily appear from the following description of the disclosed embodiments, provided as non-limitative examples, and of the accompanying drawings.

On the drawings:

FIGS. 1 and 2 are schematic views of a grinding machine,

FIG. 3A is a schematic profile view of the blade edge of the substrate according to an embodiment of the disclosure;

FIG. 3B is a schematic profile view of the blade edge of the substrate according to another embodiment of the disclosure;

FIG. 3C is a schematic profile view of the blade edge of the substrate according to another embodiment of the disclosure;

FIG. 4A is a schematic profile view of the substrate tip of the blade edge of the razor blade of FIG. 3A;

FIG. 4B is a schematic profile view of the substrate tip of the blade edge of the razor blade of FIG. 3B;

FIG. 4C is a schematic profile view of the substrate tip of the blade edge of the razor blade of FIG. 3C;

FIGS. 5A and 5B are a schematic view of the confocal measurement setup;

FIG. 6 is a schematic profile view of a blade edge of a razor blade of the disclosure with schematic coating layers;

FIG. 7 is a schematic profile view of a blade edge of a razor blade covered by coating layers of the present disclosure; and

FIG. 8A is a schematic profile view of the blade edge of a substrate covered by the hard coating according to an embodiment of the disclosure;

FIG. 8B is a schematic profile view of the blade edge of a substrate covered by the hard coating according to another embodiment of the disclosure;

FIG. 8C is a schematic profile view of the blade edge of a substrate covered by the hard coating according to another embodiment of the disclosure;

FIG. 9A is a schematic profile view of the substrate tip of the blade edge of the substrate covered by the hard coating of FIG. 8A;

FIG. 9B is a schematic profile view of the substrate tip of the blade edge of the substrate covered by the hard coating of FIG. 8B;

FIG. 9C is a schematic profile view of the substrate tip of the blade edge of the substrate covered by the hard coating of FIG. 8C;

FIGS. 10A and 10B are perspective view of two embodiments of a razor blade according to the disclosure; and

FIG. 11 is a schematic view of a shaving device comprising at least one razor blade according to the disclosure.

On the different Figures, the same reference signs designate like or similar elements.

### DETAILED DESCRIPTION

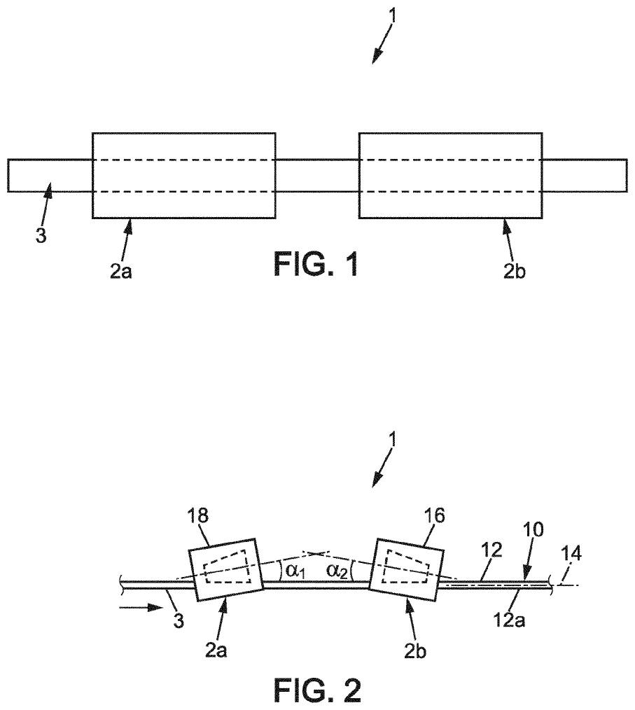

The desired blade profile of the razor blade according to the description may be achieved by a grinding process that involves one, two, three or four grinding stations. FIGS. 1 and 2 show schematically a grinding installation 1 having two stations 2a and 2b. The base material is a continuous strip 3. The continuous strip 3 is made of the raw material for the razor blade substrate, which has previously been submitted to a suitable metallurgical treatment. This is for example stainless steel.

The disclosure is also believed to be applicable to razor blades with a substrate of carbon steel. Another possible material is ceramics. These materials are considered insofar as they are suitable for razor blade materials.

The metal strip is longer than a plurality of razor blades, for example it corresponds to 1000 to-be razor blades or more.

Before grinding, the metal strip 3 has, generally speaking, a rectangular cross-section. The height of the metal strip may be slightly over the height of one finished razor blade, or slightly over the height of two finished razor blades, if grinding is to be performed on both edges. The thickness of the metal strip is the maximum thickness of the future razor blades. The continuous strip 3 has for instance a thickness which can be comprised between 74 μm and 100 μm. The strip may pass through punches which enable to carry the strip along the installation 1 during the grinding process, and/or may be used to facilitate future separation of the individual razor blades from the strip.

As the metal strip 3 moves along the grinding stations 2a, 2b, it is sequentially subjected to a rough grinding, a semi-finishing and a finishing grinding operation. Depending on the number of stations involved, the rough grinding and semi-finishing operation may be performed separately or in the same station. Thereafter, a finishing grinding operation can be required. The grinding steps are performed continuously, in that the strip is moved continuously through the stations without stopping.

When the rough grinding is performed separately, one or two grinding stations are required. Each grinding station may utilize one or two abrading wheels that are positioned parallel with respect to the moving strip. When rough grinding is performed separately, one or two grinding stations required. Each grinding station may utilize one or two abrading wheels that positioned parallel with respect to the moving strip. The abrading wheels have uniform grit size along their length. They may also be full body, helically grooved or a consecutive disc pattern along their length. The material of the abrading wheels might comprise CBN (Cubic Boron Nitride), silicon carbide and aluminum oxide or diamond.

When rough grinding and semi-finishing operations performed simultaneously, a single grinding station is required. In this case the station includes two abrading wheels formed into spiral helixes or a consecutive disc pattern with a special profile. The rotational axes of these wheels may be parallel or positioned at an angle with respect to the moving strip. The tilt angle ranges between 0.5° and 5°. The grit size of the wheels may also be uniform or progressively decreasing along their length towards the exit of the strip. The abrasive material of the wheels may be CBN (Cubic Boron Nitride), silicon carbide and aluminum oxide or diamond.

The finishing operation requires a single grinding station with 2 abrading wheels positioned at an angle with respect to the moving strip. The tilted angle ranges between 1° and 5.5°.

The wheels form spiral helixes and are specially profiled as well. The abrasive material can be CBN (Cubic Boron Nitride), silicon carbide and aluminum oxide or diamond. The length of the wheel may also range between 3 to 8 inches (7.62 cm to 20.32 cm).

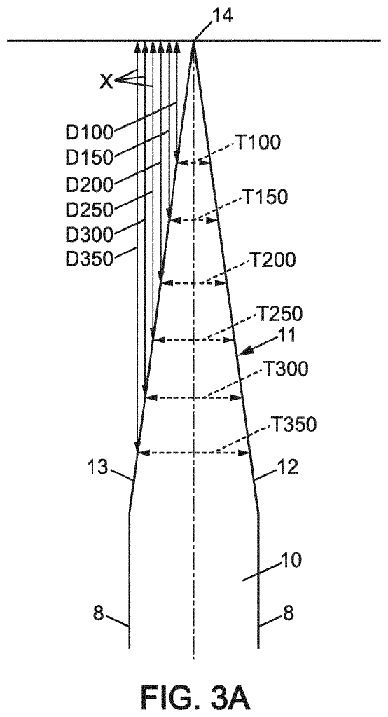

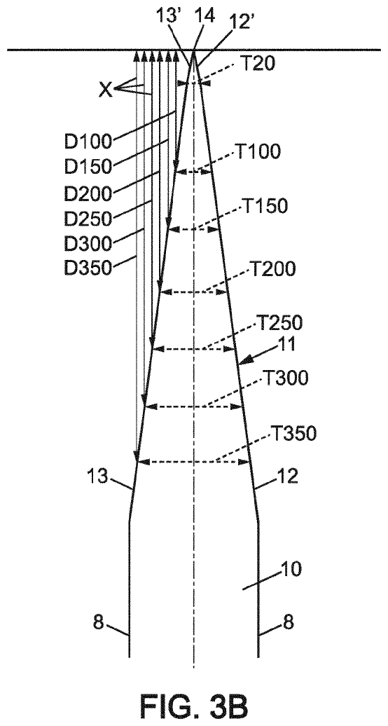

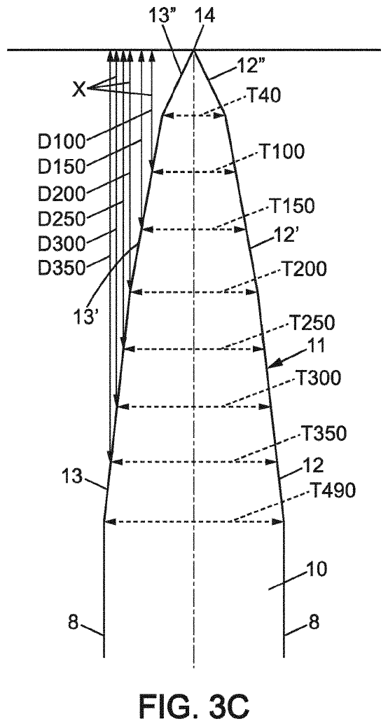

The process is tuned so as to obtain a symmetrical razor blade substrate 10 with a tapering geometry toward a substrate tip 14, as shown in FIGS. 3A-3C. The tapering geometry is continuous along the profile and may be provided with one, two or three adjacent facets as respectively depicted on FIGS. 3A, 3B and 3C.

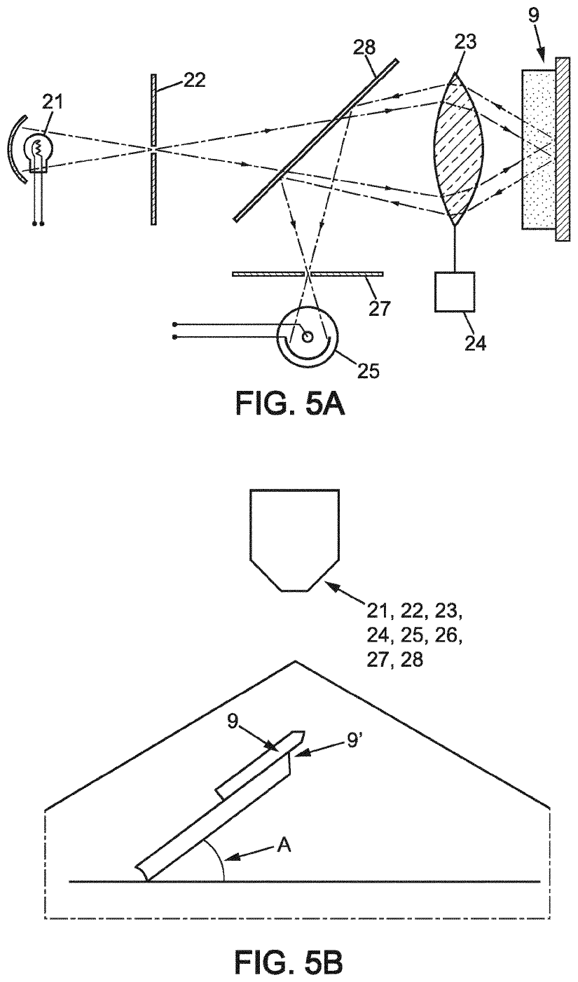

For the measurement of the blade geometry, surface roughness and grinded angle, a confocal microscope has been used. A typical example is shown on FIGS. 5A and 5 B. The confocal microscope comprises a LED light source 21, a pinhole plate 22, an objective lens 23 with a piezo drive 24 and a CCD camera 25. The LED source 21 is focused through the pinhole plate 22 and the objective lens 23 on to the sample surface, which reflects the light. The reflected light is reduced by the pinhole of the pinhole plate 22 to that part which is in focus, and this falls on the CCD camera. The sample shown here represents schematically a razor blade 9. The razor blade is used with its side angled with respect to the lens focus axis passing through the lens 23 within the device.

As depicted schematically on FIG. 5b, the blade 9 is oriented with regard to the confocal microscope with an angle A comprised between 25° and 35°, preferably of 30°. The blade 9 can be maintained in place on a magnetic plate holder 9′.

The confocal microscope has a given measurement field of, for example 200 μm×200 μm. In the present example, a semi-transparent mirror 28 is used between the pinhole plate 22 and the lens 23 to direct the reflected light toward the CCD 25. In such case, another pinhole plate 27 is used for the filtering. However, in variant, the semi-transparent mirror 28 could be used between the light source and the pinhole plate 22, which would enable to use only one pinhole plate for both the emitted light signal and the reflected light signal.

The piezo-drive 24 is adapted to move the lens 23 along the light propagation axis, to change the position of the focal point in depth. The focal plane can be changed while keeping the dimensions of this measurement field.

To extend the measurement field (in particular in order to measure the blade edge further away from the tip), one could perform another measurement at another location, and the data resulting from all measurements can be stitched.

The other side of the blade can then be measured, simply by flipping the blade to the other side.

According to one example, one could use a confocal microscope based on the Confocal Multi Pinhole (CMP) technology.

The pinhole plate 22 has then a large number of holes arranged in a special pattern. The movement of the pinhole plate 22 enables seamless scanning of the entire surface of the sample within the image field and only the light from the focal plane reaches the CCD camera, with the intensity following the confocal curve. Thus, the confocal microscope is capable of high resolution in the nanometer range.

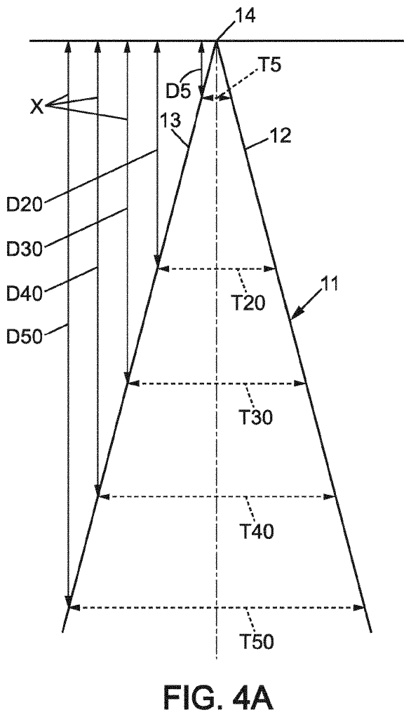

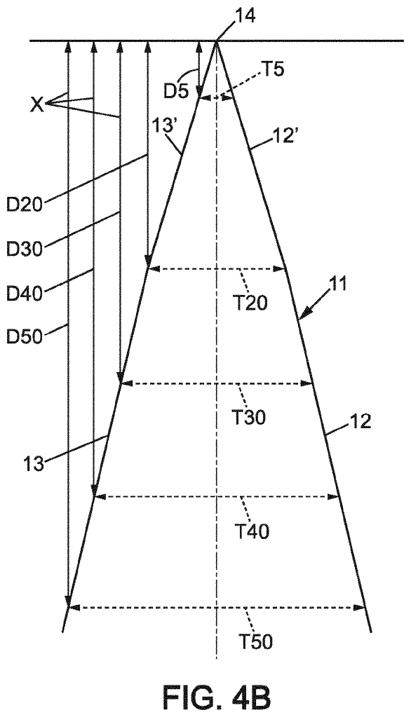

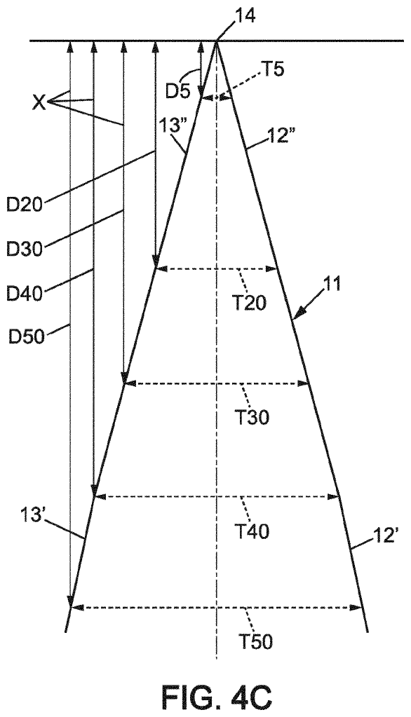

As depicted on FIGS. 3A-3C, 4A-4C and 8A-8B, the razor blade according to the description comprises a blade substrate 10 which is sharpened. The blade substrate 10 has a planar portion 8, wherein the two opposite sides of the blade are parallel to each other. Further, the blade substrate also comprises a blade edge 11, shown in cross-section on FIGS. 3A-3C and 4A-4C, connected to the planar portion 8, which sides 12 and 13 are tapered and converge to the substrate tip 14 of the blade edge 11 of the blade. The shape of the substrate 10 is profiled, meaning that the cross-section of the substrate 10 is roughly identical along the length of each facets of the razor blade.

More precisely, when the blade substrate 10 has a sole facet, more precisely a single facet 12 on one side and a single facet 13 on the other side (see FIGS. 3A and 4A), the cross-section of the substrate 10 is roughly identical along the length of the razor blade.

When the blade substrate 10 has two facets, more precisely two facets 12 and 12′ on one side and two facets 13 and 13′ on the other side (see FIGS. 3B and 4B), the cross-section of the substrate 10 is roughly identical along the length of the first facet razor blade and the cross-section of the substrate 10 is roughly identical along the length of the second facet razor blade.

When the blade substrate 10 has three facets, more precisely three facets 12, 12′ and 12″ on one side and three facets 13, 13′ and 13″ on the other side (see FIGS. 3C and 4C), the cross-section of the substrate 10 is roughly identical along the length of the first facet razor blade, the cross-section of the blade is roughly identical along the length of the second facet razor blade and the cross-section of the substrate 10 is roughly identical along the length of the third facet razor blade.

Razor blades with various geometries have been manufactured, measured, and tested for shaving performance. Manufacture includes not only substrate sharpening by grinding, but also coatings as will be described below. For the shaving tests, only the grinding step was modified in order to generate various substrate geometries, the other process steps being kept equal.

The tests determined that the thinness of the edge tip may be defined by checking the thickness of control points located 5 micrometers and 20 micrometers from the substrate tip 14. Further, the strength of the edge tip can be defined by checking the thickness of control points located 20 micrometers and 250 micrometers from the substrate tip 14.

After intense testing, it was determined that suitable shaving effects were obtained for razor blades having a substrate 10 with the following features of Table 1.

TABLE 1
Total blade edge profile

| | Lower thickness | Upper thickness |
|---|---|---|
| Distance X from the | limit (μm) of the | limit (μm) of the |
| substrate tip 14 (μm) | substrate | substrate |
| 5 | 1.3 | 2.0 |
| 20 | 4.0 | 6.0 |
| 30 | 6.0 | 8.7 |
| 40 | 8.0 | 11.5 |
| 50 | 10.0 | 14.0 |
| 100 | 19.0 | 24.0 |
| 150 | 27.7 | 32.0 |
| 200 | 34.7 | 40.0 |
| 250 | 41.7 | 47.0 |
| 300 | 48.7 | 54.0 |
| 350 | 55.7 | 61.0 |

The above dimensions can be obtained through a dispersion of products manufactured using the same manufacturing process.

The blade has a smooth profile in between and beyond (both from and away from the tip) these control points.

The blade thickness increase rate (slope) from the tip up to the transition point should be continuously decreasing, making the blade edge easier to penetrate the hair leading to better comfort. The blade profile after the transition point (from 40 μm to 350 μm) should be lying in a specific range of values in order to support a geometrically smooth transition from the first 40 μm to the unground part of the blade. In that region, the thickness increase rate is less than, or equal to, the increase rate at 40 μm.

The blade edge profile generated by the rough grinding stage, typically covering an area between 50 μm-350 μm from the substrate tip 14, determines the material removal rate of the finishing operation. Generally, the finishing grinding stage is mainly called to smoothen out the excess surface roughness produced by rough grinding along with the final shaping of the blade edge profile. For optimal process efficiency, the material removal rate of finishing grinding wheel should be kept minimum but such that the induced surface roughness ranges between 0.005 μm-0.040 μm.

For example, the thickness of the aforementioned substrate profile can be described with the following equation Y=A×Xⁿ+C.

One or more formulas can be applied one after the other to the portion of the blade extending from the substrate tip 14 to a transition point from which the substrate has an unground portion.

In one embodiment, the profile can be according to the equation Y=A×Xⁿ with constants taken from Table 2 below:

TABLE 2

| X (μm) | A | n |
|---|---|---|
| [0, 20] | 0.47 | 0.85 |
| (20, 350] | 0.55 | 0.80 |

In another embodiment, the profile can be according to the equation Y=A×Xⁿ+C with constants taken from Table 3 below:

TABLE 3

| X (μm) | A | n | C |
|---|---|---|---|
| [0, 20] | 0.47 | 0.85 | 0 |
| (20, 70] | 0.25 | 1 | 1 |
| (70, 480] | 0.14 | 1 | 8.70 |

In another embodiment, the profile can be according to the equation Y=A×Xⁿ+C with constants taken from Table 4 below:

TABLE 4

| X (μm) | A | n | C |
|---|---|---|---|
| [0, 20] | 0.47 | 0.85 | 0 |
| (20, 70] | 0.21 | 1 | 1.8 |
| (70, 480] | 0.14 | 1 | 6.70 |

The razor blade substrate 10 comprising the blade edge 11 can be made of stainless steel.

A suitable stainless steel can comprise mainly iron, and, in weight C: 0.40-0.80%; Si: 0.10-1.5%; Mn: 0.1-1.5%; Cr: 11.0-15.0%; and Mo: 0.0-5.0%.

Other stainless steels can be used within the disclosure. Other materials which are known as razor blade substrate materials can be considered.

The further manufacturing steps of a razor blade are described below.

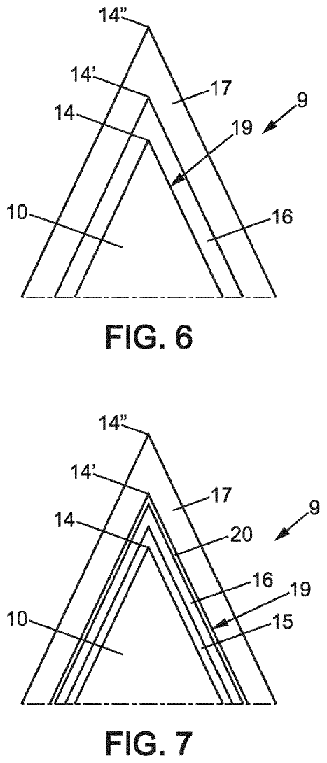

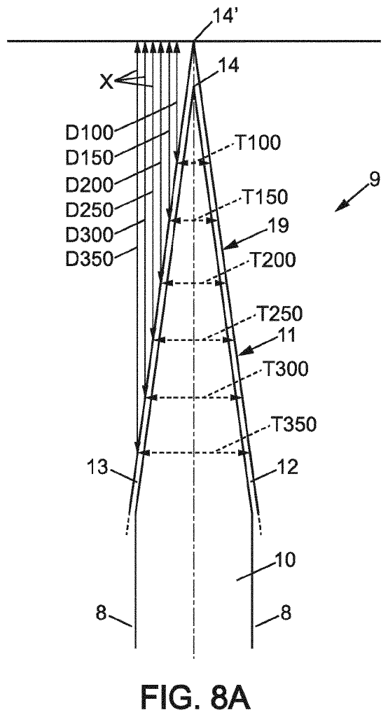

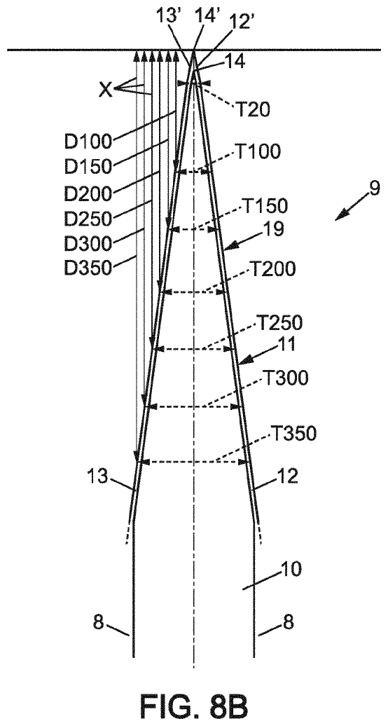

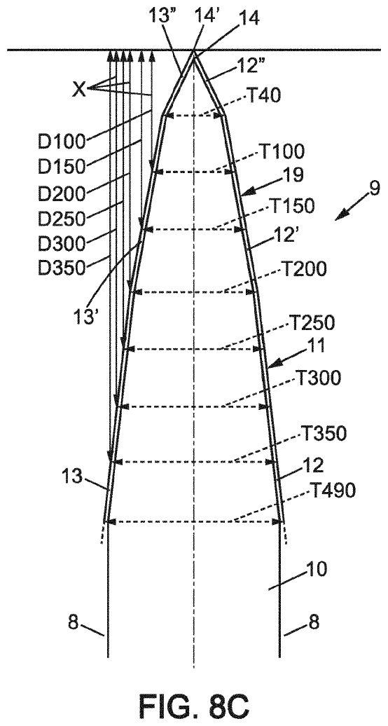

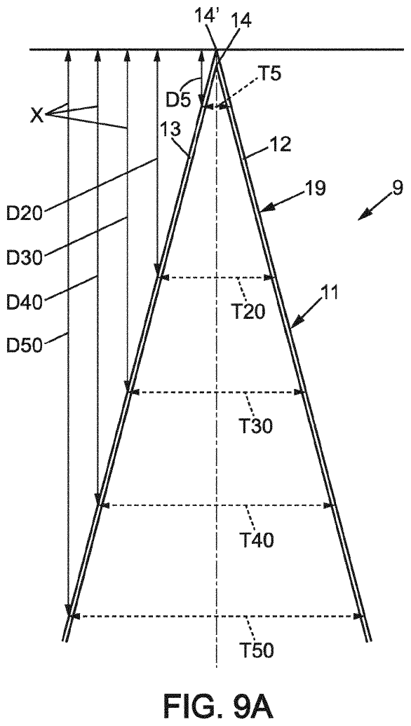

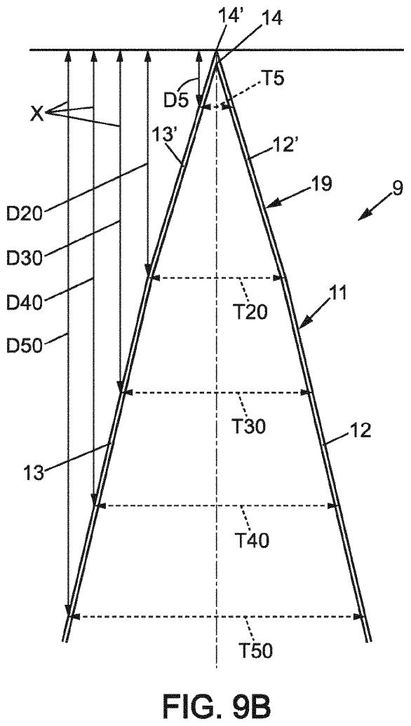

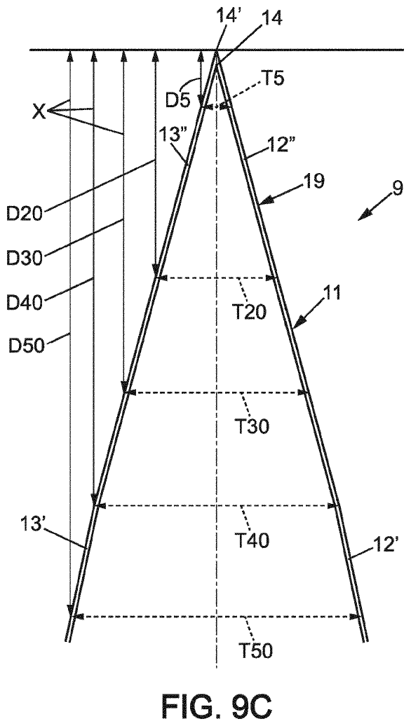

After manufacturing the substrate according to the above-mentioned technique and with the distinct values of Tables 5-12, in a second step the substrates 10 (or grinded blades) are introduced into a deposition chamber in order to be coated. The above geometry measurements were performed before this coating is applied. The coating configuration may include one or more layers, which improve the properties of the protective coating, thus an interlayer, a main layer and a soft coating can be distinguished, respectively. The interlayer and the main layer define a hard coating. The hard coating is covered by the soft coating. The coating layers enable to reduce the wear of the blade edge, improve the overall cutting properties and prolong the usability of the razor blade. The razor blade 9 covered by these several layers has still a profiled geometry and a tapering geometry with two coating sides converging toward a blade tip 14″ (see FIGS. 6 and 7). With reference to FIGS. 8A-8C and 9A-9C, the razor blade 9 according to the description would have a similar profiled geometry and a tapering geometry than the blade substrate 10 as depicted on FIGS. 3A-3C and 4A-4C taking into account that the tip is the hard coating tip 14′ for the substrate 10 covered by the hard coating, whereas it is the substrate tip 14 for the substrate 10.

As the substrate 10 having a profiled geometry and a tapering geometry with two sides converging toward a substrate tip 14, the substrate 10 covered by the main layer 16 has a profiled geometry and a tapering geometry with two coating sides converging toward a hard coating tip 14′. In addition, when provided with more than one facet 12, 13, for instance two facets 12, 12′ and 13, 13′ or three facets 12, 12′, 12″ and 13, 13′, 13″ the substrate 14 covered by the main layer 16 has still a profile with identical number of facets (one, two or three).

As depicted on FIGS. 3A-3C and 4A-4C, the blade substrate 10 comprising a blade edge 11 having a profiled geometry and having a tapering geometry with two substrate sides 12, 13 converging toward a substrate tip 14, is covered by a main layer 16 deposited on the razor blade substrate 10 at least at the blade edge as depicted on FIG. 6. The main layer 16 is preferably a strengthening coating. This kind of layer improves corrosion resistance, edge strengthening as well as shaving performance. The coating layers enable to reduce the wear of the blade edge, improve the overall cutting properties and prolong the usability of the razor blade.

The strengthening coating 16 covering the substrate tip 14, has a profiled geometry and has a tapering geometry with two coating sides converging toward a hard coating tip 14′. The assembly of the substrate 10 and the hard coating is designated by the expression “coated-substrate 19”.

On the embodiment depicted on FIG. 6, the blade edge substrate 10 is coated with a strengthening coating layer 16 and soft coating 17 which is a lubricating layer. In that case, the hard coating is reduced to the sole main layer 16.

The soft coating 17 can be hydrophobic or hydrophilic, such as polyfluorocarbon, for example fluoropolymer. The lubricating layer is commonly used in the field of razor blades for reducing friction during shaving.

The strengthening coating layer 16 is used for its mechanical properties; and provides corrosion resistance and edge strengthening to the razor blade. The strengthening coating layer 16 may comprise Chromium (Cr), Chromium-Platinum (Cr—Pt) mixtures, Chromium-Carbide (Cr—C) mixtures, diamond, diamond like carbon (DLC), nitrides, carbides, oxides and/or borides.

Besides, the hard coating may further comprise an interlayer (15). In that case, the blade edge 11 of the blade is covered by the interlayer 15 as depicted on FIG. 7. For example, the interlayer 15 can comprise Chromium (Cr), Titanium (Ti), Niobium (Nb), Molybdenum (Mo), Aluminum (Al), Nickel (Ni), Copper (Cu), Zirconium (Zr), Tungsten (W), Vanadium (V), Silica (Si), Cobalt (Co), or any alloy or any combination of them.

The interlayer 15 is implemented prior to the strengthening coating layer 16. Thus, the coating layer configuration of the blade edge 11 of the blade comprises an interlayer 15 covering the blade edge 11 of the blade and a strengthening coating layer 16 covering the interlayer 15. Such a covered blade has still a tapering geometry with two coating sides converging toward a hard coating tip 14′.

Further, the strengthening coating layer 16 may be covered by an overcoat layer 20. The overcoat layer 20 is located between the main layer 16 and the soft coating 17.

The overcoat layer 20 also is thus covered by the soft coating which is a lubricating layer 17 which can be hydrophobic or hydrophilic, such as polyfluorocarbon, for example fluoropolymer, as shown on FIG. 7. As depicted on FIG. 7, the coating comprises thus the soft coating 17 and a hard coating comprising the interlayer 15, the main layer 16 and the overcoat layer 20. In the absence of the interlayer 15, the coating comprises the soft coating 17 and a hard coating comprising the main layer 16 and the overcoat layer 20. The above-mentioned geometry measurements for a substrate are performed before depositing the lubricating layer 17.

The overcoat layer 20 is used to improve the adhesion of the polymeric film with the main layer. Corresponding materials that may be used to facilitate bonding of the lubricious coating to the main layer are Chromium (Cr), Titanium (Ti), Niobium (Nb), Molybdenum (Mo) or any alloy or any compound of them. In another embodiment titanium diboride can be used as an overcoat layer.

Finally, the deposition of the aforementioned layers, various Physical Vapor Deposition techniques can be implemented, such as Sputtering, RF-DC Magnetron Sputtering, Reactive Magnetron Sputtering, or Unbalance Magnetron Sputtering, E-Beam evaporation, Pulsed Laser deposition, cathodic arc deposition.

Hereafter is disclosed an example of coating procedure of a three-layer system which allows the manufacture of a razor blade according to the description. The hard coating comprises in that case the interlayer 15, the main layer 16 and the overcoat layer 20.

After loading a blade bayonets with the blade substrates on a rotating fixture, the chamber is put to a base pressure of 10⁻⁵ Torr. Then Argon (Ar) gas is inserted into the chamber up to a pressure of 8 m Torr (8.10⁻³ Torr). Rotation of the blade bayonets begins at a constant speed of 6 rpm and the targets are operated under DC current control at 0.2 A (Ampere). A DC voltage of 200 V-600 V (Volt) is applied on the stainless steel blades for 4 minutes in order to perform a sputter etching step. In another embodiment a Pulsed DC voltage of 100 V-600 V (Volt) is applied on the stainless steel blades for 4 minutes in order to perform a sputter etching step.

The deposition of the interlayer takes place after the end of sputter etching step, with the chamber pressure being adjusted to 3 m Torr. The interlayer target is operated under DC current control at 3 A-10 A (Ampere) while a DC voltage of 0 V-100 V (Volt) is applied on the rotating blades. Adjusting the deposition time, an interlayer of 5 nm-50 nm is deposited prior to the main layer. In one embodiment Ti can be the interlayer and in another one Cr can be the interlayer.

After the deposition of the interlayer, the current of the interlayer target is reduced to 0.2 A (Ampere) and the current of the main layer target(s) is increased to 3 A-6 A. A particular embodiment includes a TiB₂ compound film of 10 nm-400 nm on top of the bonding interlayer. A DC bias voltage of 0 V-600 V is applied on the rotating blades.

Moreover, on top of the main layer, a Cr soft coating is deposited with the current on the Cr target(s) at 3 A and a bias voltage of 0 V-450 V. A particular Cr layer thickness is 5 nm-50 nm.

Finally, the overall coating thickness can vary from 10 to 500 nm and preferably from 10 nm to 250 nm on each blade edge facet.

The thicknesses of the razor blades according to the description are summarized in Table 13 according to the lower and higher coating thickness. The thickness of the razor blade 9, according to the disclosure, is measured at a distance X (in micrometers) from the hard coating tip 14′. When the hard coating comprises an interlayer 15, a main layer 16 and an overcoat layer 20, then the thickness is measured at a distance X from the overcoat layer 20.

The thickness of the edge profile of the razor blade 9 is the sum of thickness of the edge profile of the uncoated blade (meaning the substrate) plus the thickness of the coating. Finally, the overall coating thickness can vary from 10 to 500 nm and preferably from 100 nm to 400 nm on each blade edge facet.

TABLE 5

| Distance X from the | | |
|---|---|---|
| hard coating tip | Lower thickness | Upper thickness |
| 14′ (μm) | limit (μm) | limit (μm) |
| 5 | 1.31 | 2.5 |
| 20 | 4.01 | 6.5 |
| 30 | 6.01 | 9.2 |
| 40 | 8.01 | 12 |
| 50 | 10.01 | 14.5 |
| 100 | 19.01 | 24.5 |
| 150 | 27.71 | 32.5 |
| 200 | 34.71 | 40.5 |
| 250 | 41.71 | 47.5 |
| 300 | 48.71 | 54.5 |
| 350 | 55.71 | 61.5 |

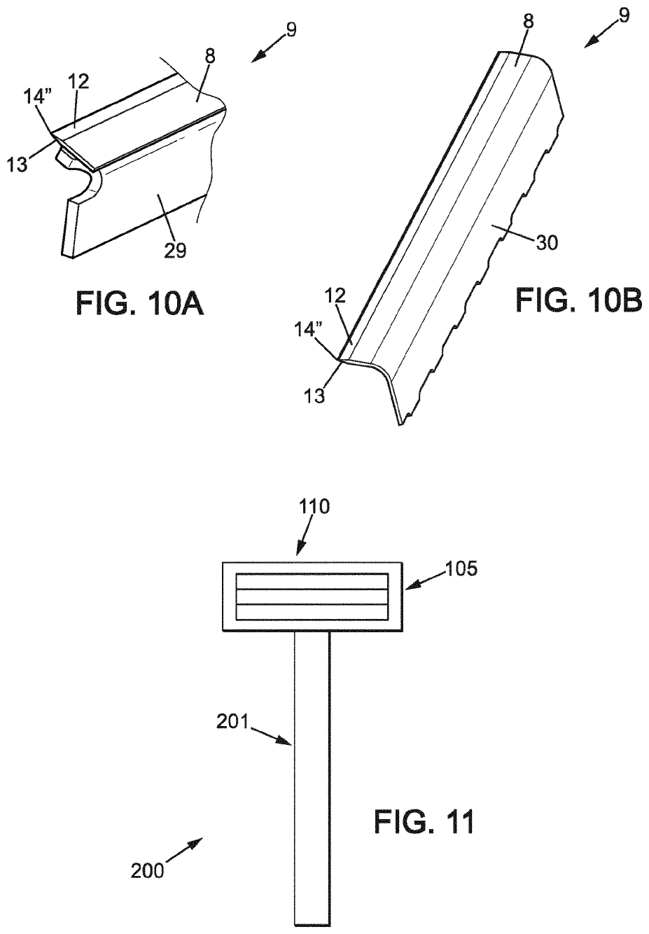

The blade can be fixed or mechanically assembled to a razor head, and the razor head itself can be part of a razor. The blade can be movably mounted in a razor head and thus mounted on elastic fingers which urge it toward a rest position. The blade can be fixed, notably welded to a support 29, notably a metal support with a L-shaped cross-section, as shown in FIG. 10A. Alternatively, the blade can be an integrally bent blade, as shown on FIG. 10B, where the above disclosed geometry applies between the blade tip 14″ and the bent portion 30.

Besides, FIG. 11 illustrates a shaving cartridge 105 having a housing 110 comprising at least one razor blade as above described. The number of razor blades can be more than one, for instance five or more or less. Such a shaving cartridge 105 can be connected to a razor handle 201 to form a shaving device 200 for shaving purposes. The shaving cartridge 105 can be removably connected to the razor handle 201. The shaving cartridge 105 can be pivotally connected to the razor handle 201.

Although the preceding description has been described herein with reference to particular means, materials and embodiments, it is not intended to be limited to the particulars disclosed herein; rather, it extends to all functionally equivalent structures, methods and uses, such as are within the scope of the appended claims.

1. A razor blade having a symmetrical tapering blade edge ending in a substrate tip, the razor blade comprising: a substrate having a thickness of between 1.30 micrometers and 2.00 micrometers measured at a distance of 5 micrometers from the substrate tip, a thickness of between 4.00 micrometers and 6.00 micrometers measured at a distance of 20 micrometers from the substrate tip, a thickness of between 8.00 micrometers and 11.50 micrometers measured at a distance of 40 micrometers from the substrate tip, and a thickness of between 41.70 micrometers and 47.00 micrometers measured at a distance of 250 micrometers from the substrate tip.

2. The razor blade according to claim 1, wherein the razor blade further comprises at least one coating.

3. The razor blade according to claim 2, wherein the coating has an overall thickness of 10 nm to 500 nm.

4. The razor blade according to claim 2, wherein the coating has an overall thickness of 100 nm to 400 nm.

5. The razor blade according to claim 1, wherein the substrate has a thickness of between 6.00 micrometers and 8.70 micrometers measured at a distance of 30 micrometers from the substrate tip.

6. The razor blade according to claim 1, wherein the substrate has a thickness of between 10.00 micrometers and 14.00 micrometers measured at a distance of 50 micrometers from the substrate tip.

7. The razor blade according to claim 1, wherein the substrate has a thickness of between 19.00 micrometers and 24.00 micrometers measured at a distance of 100 micrometers from the substrate tip.

8. The razor blade according to claim 1, wherein the substrate has a thickness of between 27.70 micrometers and 32.00 micrometers measured at a distance of 150 micrometers from the substrate tip.

9. The razor blade according to claim 1, wherein the substrate has a thickness of between 34.70 micrometers and 40.00 micrometers measured at a distance of 200 micrometers from the substrate tip.

10. The razor blade according to claim 1, wherein the substrate has a thickness of between 48.70 micrometers and 54.00 micrometers measured at a distance of 300 micrometers from the substrate tip.

11. The razor blade according to claim 1, wherein the substrate has a thickness of between 55.70 micrometers and 61.00 micrometers measured at a distance of 350 micrometers from the substrate tip.

12. A razor blade according to claim 2, wherein the coating further includes a soft coating and a hard coating, and wherein the hard coating includes an interlayer and an overcoat layer, the interlayer being located between the substrate and the hard coating, and the overcoat layer being located between the hard coating and the soft coating.

13. A razor head comprising: a housing and at least one razor blade according to claim 1.

14. A shaving device comprising: a razor handle, and a razor head, wherein the razor head includes at least one razor blade according to claim 1.
